(19) United States
(12) Patent Application Publication
(10) Pub. No.: US 2009/0229240 A1
(43) Pub. Date: Sep. 17, 2009

(54) HYBRID PLASMA FUEL ENGINE ROCKET

(76) Inventor: Keith D. Goodfellow, Valencia, CA (US)

Correspondence Address: KOESTNER BERTANI LLP, 2192 Martin St., Suite 150, Irvine, CA, 92612, US

(21) Appl. No.: 12/047,303

(22) Filed: Mar. 12, 2008

(51) Int. Cl. F03H 1/00

(52) U.S. Cl. 60/202

(57) ABSTRACT

A hybrid propulsion system for aerospace and other applications is disclosed in which a thruster is operable to release energy from a propellant, thereby producing an exhaust gas. The thruster is selectable from one of a plurality of thrusters that are different from one another. A plasma fuel engine (PFE) accelerator, which is coupled to the thruster in a tandem arrangement, provides partial ionization of the exhaust gas, an electric field, and a magnetic field. The electric field is aligned to accelerate the partially ionized exhaust gas and the magnetic field is aligned transversely to the electric field. The combination of the electric field and the magnetic field augment the specific impulse of the hybrid propulsion system.

### BACKGROUND

Performance and efficiency of various propulsion systems used in spacecrafts is often benchmarked in terms of measurements such as specific impulse (commonly abbreviated as ‘Isp’) and thrust. The Isp of a propulsion system is the impulse (or change in momentum) per unit mass of propellant. The Isp is proportional to the velocity of the exit flow. Thus, the higher the value of Isp (measured in seconds), the less propellant is needed to gain a given amount of momentum. A propulsion method is more propellant-efficient if the Isp is higher. Thrust is a measure of a momentary or peak force delivered by the propulsion system.

Each spacecraft maneuver typically requires a velocity change or delta-V of the exit flow. The propellant required to perform the maneuver is exponentially related to the delta-V and Isp as defined by the “rocket equation”. Therefore, small improvements in Isp may contribute to large reductions in the amount of propellant required. The number and magnitude of the maneuvers that may be performed by a spacecraft are generally limited by the available propellant load.

Current propulsion systems may be typically classified into chemical propulsion, electrical propulsion, solar thermal propulsion, and nuclear propulsion, in accordance with the type of energy source used. In chemical propulsion, the Isp is limited by the energy available when molecules combine. In contrast, with electric propulsion, energy is added from an external source. In principle, therefore, the Isp of electric propulsion can be as large as desired. In practice, the Isp is limited by the particular implementation. Since thrust will decrease as the Isp increases for a given power, a tradeoff is often made for a particular mission between propellant usage and mission time. As described earlier, high Isp typically leads to low propellant usage.

There are three main types of electric thrusters used in electric propulsion: electrothermal, electromagnetic, and electrostatic. Electrothermal thrusters are similar to standard chemical rocket engines in that heat energy is added to a working fluid in a confined volume, raising its pressure, but differ in that the heat is produced by electrical means (often an electrical discharge). The exhaust gas produced is subsequently expanded through a converging-diverging nozzle to achieve thrust just as in chemical rockets. The specific impulse is typically limited by the material thermal limits.

There are a variety of electromagnetic thruster configurations, but many of them depend on generating a thrust by accelerating particles in a direction perpendicular to both the electric and magnetic fields in a plasma. Plasma (also referred to as ionized gas) is an energetic state of matter in which some or all of the electrons have become separated from the atom. Formation of a plasma requires then, at least partial ionization of neutral atoms and/or molecules of a medium. There are several ways to cause ionization including collisions of energetic particles, strong electric fields, and ionizing radiation. The energy for ionization may come from the heat of chemical or nuclear reactions of the medium, as in flames, for instance.

There are two broad categories of plasma, hot plasma and cold plasma. In hot plasma, full ionization takes place, and the ions and the electrons are in thermal equilibrium. A cold plasma (also known as a weakly ionized plasma) is one where only a small fraction of the atoms in a gas are ionized, and the electrons reach a very high temperature, whereas the ions remain at the ambient temperature or slightly above. Cold plasma can be created by using a high electric field, or through electron bombardment from an electron gun, or by other means.

Examples of the electromagnetic thruster include the pulsed plasma microthruster (PPT) and a magnetoplasmadynamic (MPD) thruster. The PPT utilizes a spark discharge across a block of TEFLON® to create plasma, which is accelerated outward by induced azimuthal current interacting with a radial magnetic field. In the self-field MPD thruster, the current flow creates its own magnetic field in which the jxB force accelerates the plasma flow radially and axially. This can only occur if the current and hence the power are high, often necessitating pulsed operation at lower average powers.

Gridded electrostatic thrusters accelerate charged particles in an electric field, without an applied magnetic field. Gridded electrostatic ion thrusters use an electric field formed between a set of grids to accelerate charged ions. Electrons are also expelled separately to maintain charge neutrality and prevent a charge buildup which could shut off the ion beam. Heavy gases such as mercury vapor and xenon have been used to reduce ionization losses as a fraction of total energy. Ionization losses are approximately the same for most gases, whereas for a given exhaust velocity the energy added per ion is greater for heavier gases. In electrostatic thrusters, the beam consists of ions only and repulsion between particles limits the maximum density to relatively low levels, sometimes called the “space charge effect”. The space charge effect limits gridded electrostatic thrusters to significantly lower thrust than other types of electric thrusters.

In a Hall thruster, which is a type of an electrostatic thruster, an axial electric field is concentrated in the region of the externally applied radial magnetic field. The combination of the axial electric field and the radial magnetic field creates an azimuthal Hall current with the electrons. The azimuthal electrons collide with incoming neutral atoms to form positively charge ions. The ions are created in the high electric field area and then are axially accelerated out of the thruster to produce the thrust. Since both electrons and ions are present in the acceleration region, the thrust density is not limited by space-charge. The larger mass of the ions prevents them from also being driven azimuthally within the thruster. Hall thrusters also traditionally use high molecular weight propellants, including xenon and krypton in particular.

In general, electromagnetic and electrostatic thrusters have much higher Isp than electrothermal thrusters, and electrothermal thrusters have a higher Isp than chemical thrusters. Also, chemical thrusters have much higher thrust to weight ratios than electrothermal thrusters, and electrothermal thrusters have a higher thrust to weight ratios than electromagnetic thrusters. For example, Isp of hydrazine chemical monopropellant rockets is limited to about 230 seconds. For hydrazine and ammonia propellant arc-heated rockets (often referred to as arcjet thrusters) the Isp is limited to about 600 seconds. In comparison, Isp for electrostatic thrusters such as a Hall thruster is about 1000 seconds to 2000 seconds. Electromagnetic thrusters are more compact than electrostatic ion thrusters because a charge neutral plasma does not have a space charge limitation on density. Problems with electromagnetic thrusters include electrode erosion and general complexity of flow and current fields. The PPT thruster is mature and simple, but may not scale up to large powers. The specific impulse of electrothermal thrusters such as arcjet thrusters is limited by the lifetimes on the electrode materials.

Consequently, present spacecraft propulsion systems that are capable of providing both a high thrust (rapid transfer) and a low-thrust, high specific impulse require separate and disparate propulsion systems. However, weight and complexity of a spacecraft having separate and disparate propulsion systems make such solutions impractical, unreliable, inefficient, and costly.

### SUMMARY

In some embodiments, a hybrid propulsion system for aerospace and other applications is disclosed in which a thruster is operable to release energy from a propellant, thereby producing an exhaust gas. The thruster is selectable from one of a plurality of thrusters that are different from one another. A plasma fuel engine (PFE) accelerator, which is coupled to the thruster in a tandem arrangement, provides partial ionization of the exhaust gas, an electric field, and a magnetic field. The electric field is aligned to accelerate the partially ionized exhaust gas and the magnetic field is aligned transversely to the electric field. The combination of the electric field and the magnetic field augment the specific impulse of the hybrid propulsion system.

The foregoing has outlined rather broadly the features and technical advantages of embodiments of the present invention so that those skilled in the art may better understand the detailed description of embodiments of the invention that follows.

### BRIEF DESCRIPTION OF THE DRAWINGS

Embodiments disclosed herein may be better understood, and their numerous objects, features, and advantages made apparent to those skilled in the art by referencing the accompanying drawings. The use of the same reference symbols in different drawings indicates similar or identical items.

FIG. 1 is a diagram of an embodiment of a hybrid propulsion system;

FIG. 2A is a diagram of an embodiment of components that can be included in a plasma fuel engine (PFE) accelerator described with reference to FIG. 1;

FIG. 2B is a diagram of an embodiment of components that can be included in a segmented electrode configuration of a plasma fuel engine (PFE) accelerator described with reference to FIG. 1;

FIG. 3 is an exemplary diagram illustrating operation of electric and magnetic fields within a PFE accelerator described with reference to FIG. 1 and FIGS. 2A and 2B;

FIG. 4 is a diagram of an embodiment of a test system for testing performance of a hybrid propulsion system described with reference to FIG. 1, FIGS. 2A and 2B and FIG. 3;

FIG. 5 is a graphical representation of a theoretical efficiency of a PFE accelerator described with reference to FIG. 1, FIGS. 2A and 2B, FIG. 3 and FIG. 4; and

FIG. 6 is an embodiment in the form of a flow chart illustrating a method for producing propulsion using a PFE accelerator described with reference to FIG. 1, FIGS. 2A and 2B, FIG. 3, FIG. 4, and FIG. 5.

### DETAILED DESCRIPTION OF THE FIGURES

Applicant recognizes the need for an improved propellant efficient space propulsion system that is capable of providing adjustable levels of both a high thrust (rapid transfer) and a low-thrust, high specific impulse, using a common propellant, absent the disadvantages found in the prior techniques discussed above. For example, a high Isp may be desired for extending the spacecraft lifetime, while a variable Isp may be desired for optimizing mission profiles and reducing propellant mass. As another example, it may be desirable to have a selectable mode of operation between high-thrust and high-Isp modes to change satellite trajectories, e.g., for threat avoidance or repositioning, using a single propellant source. A hybrid propulsion system based on a plasma fuel engine (‘PFE’) concept, as disclosed here in, would permit operation in both a high thrust (rapid transfer) mode and a low-thrust, high specific impulse mode.

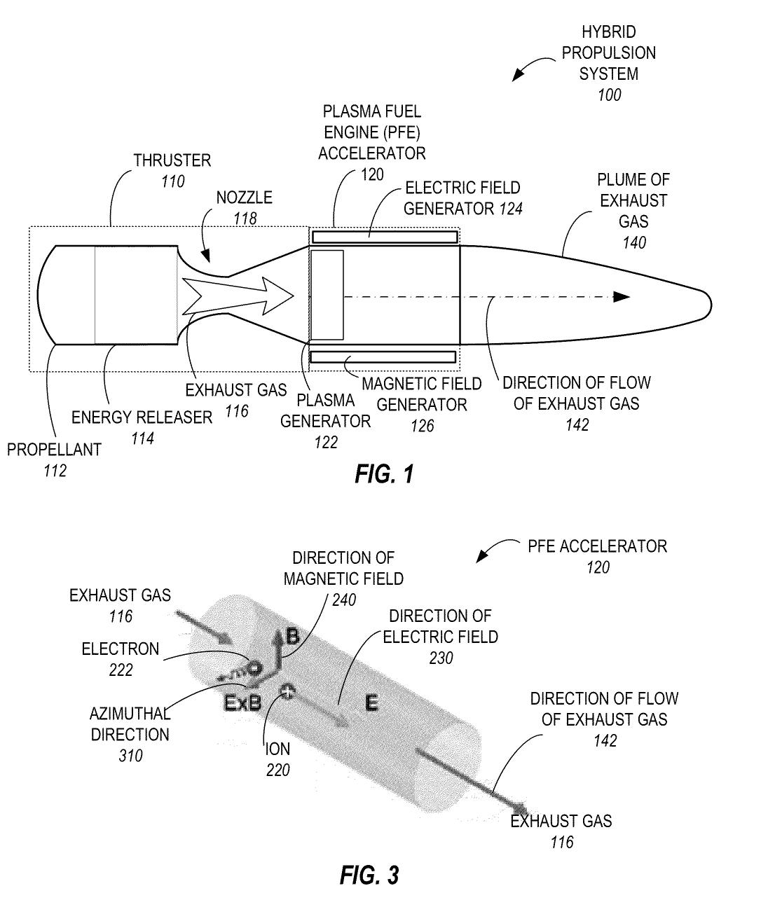

FIG. 1 shows a diagram of components that can be included in some embodiments of a hybrid propulsion system 100, including a thruster 110 that is coupled to a plasma fuel engine (PFE) accelerator 120 in a tandem arrangement. The PFE accelerator 120 is disposed at a downstream location relative to the thruster 110. The thruster 110 is selectable from a plurality of thrusters (not shown) that are different from one another. For example, the plurality of thrusters may include conventional chemical thrusters and electrothermal thrusters.

The thruster 110 includes an energy source such as a propellant 112 that is provided to an energy releaser 114. The propellant 112 may be stored in a storage tank and provided to the energy releaser 114 in a controlled manner. The energy releaser 114 is operable to release energy stored in the propellant 112, thereby producing an exhaust gas 116. The flow of the exhaust gas 116 in a controlled manner generates an adjustable level of a thrust and an adjustable level of an Isp for the hybrid propulsion system 100. For example, the energy releaser 114 releases heat energy in a controlled manner by triggering a chemical reaction or by initiating an electrical discharge such as in an arcjet thruster to produce the heat. The heat energy when added to a working fluid derived from the propellant 112 and contained in a confined volume of the energy releaser 114 raises the internal pressure. The exhaust gas 116, which is derived from the propellant 112, is subsequently expanded through a converging-diverging nozzle 118 to achieve the desired thrust for the spacecraft.

Each one of the plurality of thrusters is advantageously fueled by a single source of the propellant 112. This reduces the weight and the complexity of the hybrid propulsion system 100 for the spacecraft. The propellant 112 is a material that is discharged by the hybrid propulsion system 100 of a spacecraft giving it a forward thrust. The propellant 112 may include a fuel and an oxidizer that are combinable for providing the propulsion. The propellant 112 is selectable to be one of a monopropellant and a bipropellant. Other more complex types of propellants, including tripropellants, may also be supported by the thruster 110. A monopropellant is typically a liquid chemical fuel that does not require a separate oxidizer to release energy. A bipropellant typically includes 2 separate propellants, which release energy when combined. A tripropellant typically includes 3 separate propellants (e.g., a mixture of lithium, hydrogen, and fluorine), which release energy when combined. Chemical thrusters and electrothermal thrusters are typically propelled by a monopropellant such as Hydrazine. Some arc-jet thrusters may utilize Hydrazine or ammonia propellants.

The Isp or exit flow velocity of the exhaust gas 116 that is produced by the thruster 110 is advantageously accelerated by adding the PFE accelerator 120 to the end of the thruster 110. The PFE accelerator 120 advantageously deploys a Plasma Fuel Engine (PFE) concept to boost or augment the Isp or exit flow velocity of the exhaust gas 116. The PFE accelerator 120 includes a plasma generator 122 to provide partial ionization of the exhaust gas 116, an electric field generator 124 to provide an electric field, and a magnetic field generator 126 to provide a magnetic field. The electric field is aligned to accelerate the exhaust gas 116 in a direction 142 of the flow and the magnetic field is aligned transversely to the electric field. Thus, a controlled flow of the exhaust gas 116 through the nozzle 118 and through the PFE accelerator 120 generates an adjustable level of a thrust and an adjustable level of a specific impulse. The exhaust gas 116 forms a plume 140 upon exiting the PFE accelerator 120.

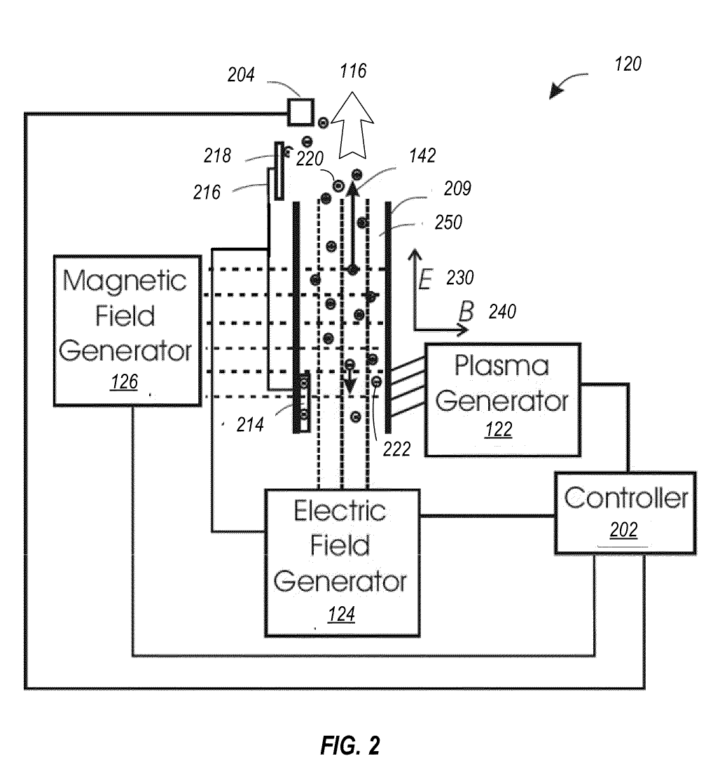

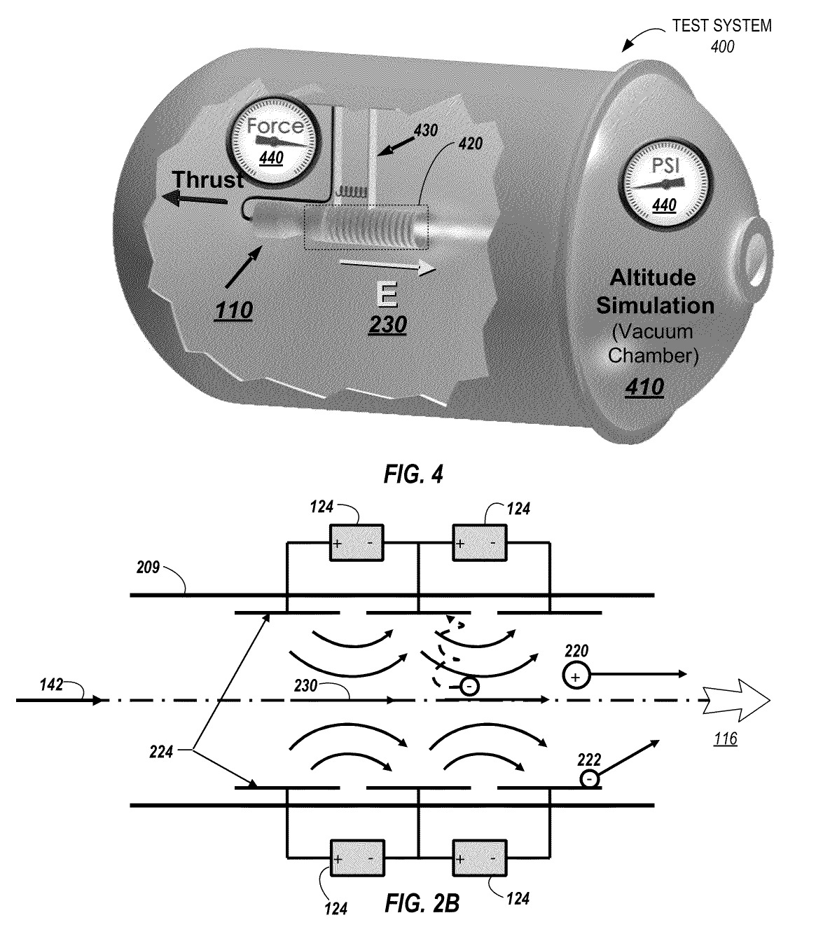

Coupling the PFE accelerator 120 to the thruster 110 (selectable to be one of conventional chemical thrusters and electrothermal thrusters, for example) advantageously provides an improved hybrid propulsion system capable of providing improved Isp and improved efficiency relative to corresponding Isp and efficiency of the traditional chemical and arcjet thruster acting alone. The hybrid propulsion system 100 utilizes electrostatic body forces to accelerate the propellant 112, which is more efficient than the heating used in the conventional chemical and arcjet thrusters. Although the PFE accelerator 120 is capable of being added to either a chemical rocket or an electrothermal thruster, the PFE accelerator 120 may provide an increased benefit when used in combination with an arcjet source since the ionization fraction of the source plume is likely to be greater. Conventional Hall space thrusters have higher Isp but have low thrust (or low thrust density) values compared to the hybrid propulsion system 100. Thus, the hybrid propulsion system 100 advantageously has the potential to provide both high-Isp and high-thrust using a single propellant system. Additional detail of the PFE accelerator 120 is described with reference to FIGS. 2A, 2B and FIG. 3. The hybrid propulsion system 100 may be advantageously scaled from 1 kilowatt to over 100 kilowatt, making it adaptable to provide a wide range of thrust and Isp.

The hybrid propulsion system 100 is also capable of on-board power generation. For example, the direction of the electric field may be easily reversed to place the PFE accelerator 120 in a reverse or decelerator mode. That is, instead of accelerating the flow of the exhaust gas 116, the PFE accelerator 120 may be operated in deceleration/power extraction mode to extract momentum from the exhaust gas 116. The extracted momentum is converted to electrical power, thereby providing an additional on-board power source at the expense of the propellant.

Referring to FIG. 2A, an embodiment of components that can be included in some embodiments of a PFE accelerator described with reference to FIG. 1 is shown. Referring to FIG. 2B an embodiment of components that can be included in a segmented electrode configuration of a PFE accelerator described with reference to FIG. 1 is shown. Referring to FIGS. 2A and 2B, the PFE accelerator 120 includes a controller 202 coupled to operate a plasma generator 122, an electric field generator 124, and a magnetic field generator 126. The exhaust gas 116 flows through an inlet opening of a housing 209 of the PFE accelerator 120 and exits through an outlet opening of the housing 209. The inlet opening of the housing 209 is designed to mate with a corresponding outlet opening of the nozzle 118 of the thruster 110. The direction 142 of the flow of the exhaust gas 116 is axially outward of the housing 209, e.g., from the inlet opening towards the outlet opening. Controller 202 can be configured to receive information from one or more sensor(s) 204 regarding the characteristics of flow of the exhaust gas 116 within housing 209, and/or at a downstream location to control operation of the plasma generator 122, electric field generator 124, and magnetic field generator 126.

Plasma generator 122 can be configured to partially ionize the exhaust gas 116 to form and sustain the plasma in the housing 209. The partial ionization of the exhaust gas 116 produces ions 220 and electrons 222 in substantially equal numbers to form the quasi-neutral plasma. Electric field generator 124 is configured to provide an electric field 230. The electric field 230 is used to accelerate the ions 220 within a cavity 250 enclosed by housing 209, the direction of the electric field 230 being toward the outlet opening in housing 209. Magnetic field generator 126 can be configured to provide a magnetic field 240 to direct the flow of the electrons 222, the orientation of the magnetic field 240 being transverse to the electric field 230. Controller 102 is operable to control strength and direction of the electric field 230 and the magnetic field 240 to adjust the thrust and Isp of the hybrid propulsion system 100.

The force of magnetic field 240 mitigates the momentum of the electrons 222, which aids collection of the electrons by a positive electrical terminal, such as an anode 214. Anode 214 can be coupled to a conductive element 216 and configured to transport the electrons 222 to a downstream location. Electrodes 224 coupled to the electric field generator 126 for providing the electric field 230 are arranged in a segmented arrangement (referred to as segmented electrodes or shunt rings) along the walls of the housing 209 of the accelerator tube. These electrodes also serve to shunt the transverse induced electric field and collect the electrons 222. The Lorentz or ExB force moves the electrons 222 towards the wall. The aft most electrode 224 (serving as cathode 218) can be coupled to the other end of conductive element 216 at the downstream location, where the electrons can be re-inserted into the flow of the exhaust gas 116 to neutralize the charge. Additional detail of the acceleration of the exhaust gas 116 by electromagnetic fields within the PFE accelerator 120 is described with reference to FIG. 3.

Any suitable component or combination of components can be used for plasma generator 122, electric field generator 124, and magnetic field generator 126. For example, plasma generator 122 can be implemented by strong electric fields, electron beams, microwaves, and other phenomena and/or components capable of generating plasma. The plasma generator 122 can inject energy, such as electron beams or alpha, beta, or gamma beams from decay of radioactive isotopes into cavity 250 through windows or other suitable structures to ionize incoming flow of the exhaust gas 116. For example, in some configurations, thin metallic foils with passive cooling can be utilized. In other configurations with electron beams of relatively high current densities, either active cooling or plasma windows can be utilized. The structures through which plasma generator 122 injects ionizing energy typically comprise only a portion of one or more walls of housing 209 and can be configured using any suitable number, shape, and location on housing 209.

FIG. 3 shows an exemplary diagram illustrating operation of electric and magnetic fields within a PFE accelerator described with reference to FIG. 1 and FIGS. 2A, 2B. The electric and magnetic fields can be orientated to generate the desired net thrust. If only an electric field 230 is applied, the positive particles, e.g., the ions 220, and negative particles, e.g., the electrons 222, will be accelerated in opposite directions. Given the Law of Conservation of Momentum, each particle attains equal but opposite momentum and there is no net change in momentum; equal but opposite thrust (which is based on the time rate of change of momentum) implies zero net thrust. The magnetic field 240 is then applied to cause the electrons 222 to flow in an azimuthal direction 310 and spiral around the magnetic field lines, thus progressing through the electric field much more slowly than they would otherwise. The magnetic field can be oriented in any direction that forces the electrons to take a longer path through the electric field 230 than the ions 220. As described earlier, one way to regulate the thrust generated by the PFE accelerator 120 is to control the intensity and orientation of the electric and magnetic fields 230 and 240. As shown, the magnetic field 230 is applied normal to the direction of the exhaust gas 116, which creates the largest force on the electrons, mitigating the momentum of the electrons, and creating the maximum net thrust.

The Lorenz equation relates the electromagnetic force on a moving charged particle to the vector sum of the electric field 230 and the cross product of the particle's velocity with the magnetic field 240 as follows:

F=q(E+vxB)

where F is the force on the particle, q is the charge of the particle, E is the strength of the electric field 230, v is the speed of the particle, and B represents the strength of the magnetic field 240. Clearly, the magnetic field will not exert force on a charged particle if the velocity of the charged particle (with respect to that field) is zero. By contrast, the electric field will exert force on the particle regardless of the particle's velocity. The Lorenz equation thus implies that kinetic energy can be added to a moving ion by an electrical field, but not by a magnetic field. Accordingly, hybrid propulsion system 100 is configured to place a positive and negative charged particle in close proximity, and subject both to an electric field that accelerates the positive charged particles in the opposite direction of the negative charged particles.

Hybrid propulsion system 100 requires that, of the two types of particles present in the plasma (e.g., positive and negative), the particles be of substantially different masses, so that, given the same force, particles of one charge accelerate faster than particles of the opposite charge. The charge-to-mass ratio of an electron is on the order of 1.8×10¹¹ while the average air ion has a charge-to-mass ratio of 3.3×10⁶ (in coulombs per kilogram), which is five orders of magnitude difference. Given a constant magnetic field, the electrons will accelerate to very high velocity while during the same time period the ions will accelerate only to velocity five orders of magnitude less. The speed differential implies the electrons will be strongly affected by a magnetic field, while the ions will be affected only very weakly by comparison. Thus, the magnetic field can be used to sort between the charged particles, letting the heavier particle fall under the influence of the electric field alone while the light particles feel the influence of both electric and magnetic fields. The electrons thus collected by and trapped in the magnetic field can be conducted through electrodes and re-inserted into exhaust gas 116 at a downstream location to maintain charge neutrality.

FIG. 4 shows a diagram of components that can be included in some embodiments of a test system 400 for testing performance of a hybrid propulsion system 100 described with reference to FIG. 1, FIGS. 2A, 2B, and FIG. 3, including a high-altitude simulation/vacuum chamber 410, a PFE accelerator system 420, and a thrust stand 430. One or more instruments 440 are operable to measure process variables such as propellant mass flow rate, simulation chamber pressure, propellant source pressure, thrust, electrical properties, e.g., currents and voltages and similar others.

The PFE accelerator system 420 is secured to the thrust stand 430. The PFE accelerator system 420 includes a magnetic field generator for providing a magnetic field (not shown), and an electric field generator for providing an electric field 230. The PFE accelerator system 420 has a desirable gas density near 3×10 raised to the power of 16 molecules/cubic centimeters, which corresponds to a static pressure of about 1 Torr at near-room temperature. The high-altitude simulation/vacuum chamber 410 can be maintained well below 1 Torr under continuous operation by continuously evacuating the chamber 410 with a set of large vacuum pumps (not shown). Therefore, the test system 400 can be operated in a steady-state mode.

Based on the measurements measured by the instruments 440 the thrust efficiency of the PFE accelerator system 420 can be calculated. In addition to or in lieu of direct measurements, empirical formulae, computer simulation tools or theoretical models may also be used to predict or estimate new measurements, and validate collected measurements. The thrust is determined by measuring a displacement of the free end of a cantilevered beam of the thrust stand 430. A set of known calibration weights are applied to the system in situ for performing calibration. The flow rate is directly measured and the electrical power is determined from direct current and voltage measurements. Thus, the specific impulse and the thrust efficiency may be determined from the direct measurement

Without an applied magnetic field, no increase in thrust is measured. When a small magnetic field (e.g., 0.1 to 0.2 Tesla) is applied, a positive net body force is applied to the charged particles (including positive ions and electrons), and a net gain in thrust is observed. Also, with the magnetic field, the discharge impedance is increased. This is an independent indication that the electron flow is reduced. Experimental test data suggests that variations in the geometry, position, and number of anodes and cathodes, in the structure of electrical grading rings/segmented electrodes 224 that surround the discharge, as well as in the levels of pre-ionization used for discharge initiation, did not exhibit anything that prevented thrust generation; the measured thrust was robust to these variations. Tests may be performed with and without the PFE accelerator system 420 in operation to quantify the amount of additional thrust and specific impulse resulting from the PFE accelerator system 420. As described earlier, the PFE stage (including the PFE accelerator system 420 and the PFE accelerator 120) may be operated in a power generation mode. The test system 400 may be used to quantify the decrease in thrust and specific impulse and compute an amount of energy generated from the flow.

An efficiency of the PFE accelerator 120, as tested and simulated by the PFE accelerator system 420, is a function of the velocity of the exhaust gas 116 and the gas density/pressure of the exhaust gas 116. The efficiency of the PFE accelerator 120 is the useful push work performed divided by the power input. The PFE accelerator 120 has a higher efficiency than a traditional, ground based, Faraday-type (electric field and magnetic field are both oriented transverse to the direction of the gas flow) MHD accelerator. That is, for a particular value of a magnetic field strength, the PFE accelerator 120 provides higher power efficiency compared to a traditional MHD device. The required magnetic field strength within the PFE accelerator 120 is proportional to the gas density of the exhaust gas 116. For example, if the gas density inside the housing 209 is 10 to the power of 16 molecules per cubic centimeters, a magnetic field of 0.1 Tesla will deflect the electrons more than 90 degrees between collisions, thereby preventing the electrons from transferring their momentum upstream. The reduced value of the magnetic field 240 for the PFE accelerator 120 is sufficient to slow the electrons, thereby improving the Isp. The lower value of magnetic field 240 advantageously results in lowering the weight of the magnets by about 2 orders of magnitude relative to magnets used in typical ground based Faraday-type MHD devices. Thus, the reduced magnetic field strength within the PFE accelerator 120 advantageously alleviates problems due to weight, power, and cooling associated with generating the magnetic field.

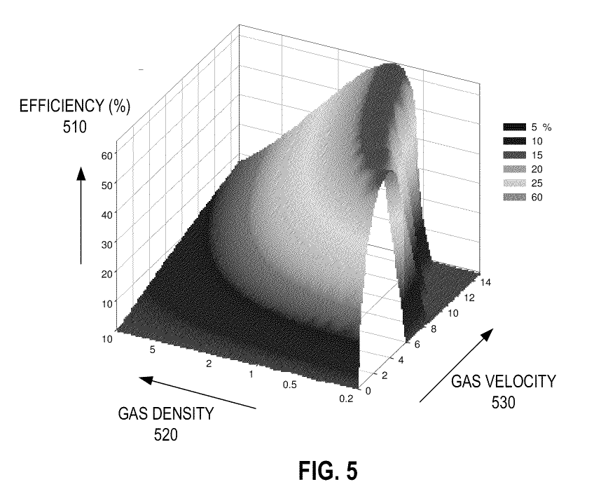

Although the orientation of the electric field and the magnetic field within the PFE accelerator 120 is similar to that of a traditional Hall thruster, the hybrid propulsion system 100 provides distinctive advantages such as being able to operate on various propellants rather than inert gas only propellants. The gas density of the exhaust gas 116 produced by the thruster 110 is about 100-1000 times higher compared to the gas density of the inert gas propellant such as Xenon used in the traditional Hall thruster. Analyses of data indicates that the efficiency of coupling electrical power to thrust is optimum at flow speed or velocity of dry air, which simulates the exhaust gas 116, approaching 1000 meters per second and higher. Additional detail of the efficiency of the PFE accelerator 120 is described with reference to FIG. 5.

The PFE accelerator system 420, and hence the PFE accelerator 120, is advantageously operable in a low fractional level of ionization (e.g., 10 to the power of −5) in the exhaust gas 116 that is flowing within the housing 209. Operation of the hybrid propulsion system 100 in a weak ionization fraction is another distinctive advantage compared to the traditional Hall thruster. The ionization (quasi-neutral plasma) is advantageously maintained, without seeding, by the electric field 230 that is oriented in the direction of the flow of the exhaust gas 116. The strength of the electric field 230 is desired to be between 1000 to 10,000 Volts/meter. The electric field selectively heats the electrons of the exhaust gas 116 in the axial electric field, thereby causing an initial partial ionization.

The high strength of the electric field 230 also sustains the plasma without seeding by the targeted heating of the electrons. As described earlier, the electric field 230 causes electrons to flow towards the PFE accelerator 120 inlet and the ions to drift towards the outlet. Without a magnetic field, the electrons and ions transfer equal and opposite amounts of momentum to the exhaust gas 116. However, with the application of a transverse magnetic field, the forward flow of electrons is slowed while the aft flow of ions is nearly unaffected. Consequently, there is a net momentum transfer to the exhaust gas 116 resulting in an increased thrust and Isp. In some thrusters such as in an arcjet thruster, the exhaust gas 116 may be already partially ionized due to the electric arc. This may advantageously reduce the ionization energy required for the PFE accelerator 120, thereby further improving its efficiency.

Referring to FIG. 5, a graphical representation of a theoretical efficiency of a PFE accelerator described with reference to FIG. 1, FIGS. 2A and 2B, FIG. 3 and FIG. 4 is shown. The efficiency 510 (Z axis) of the PFE accelerator 120 operating in a magnetic field of known strength is plotted against gas density 520 (Y axis) and gas velocity 530 (X axis). The graphical representation indicates that the PFE accelerator 120 performs efficiently in the low-density and high-speed gas flows, e.g., 1000 meters per second and higher, that may be found naturally in chemical rocket and arcjet thruster exhausts. The efficiency 510 increases with the magnetic field strength and saturates with the onset of an “ion slip” phenomenon (e.g., the retardation of the momentum-transferring downstream drift of ions). The desired magnetic field strength is between 0.1- to 0.2 Tesla, which is quite low compared with that typically used in traditional MHD devices.

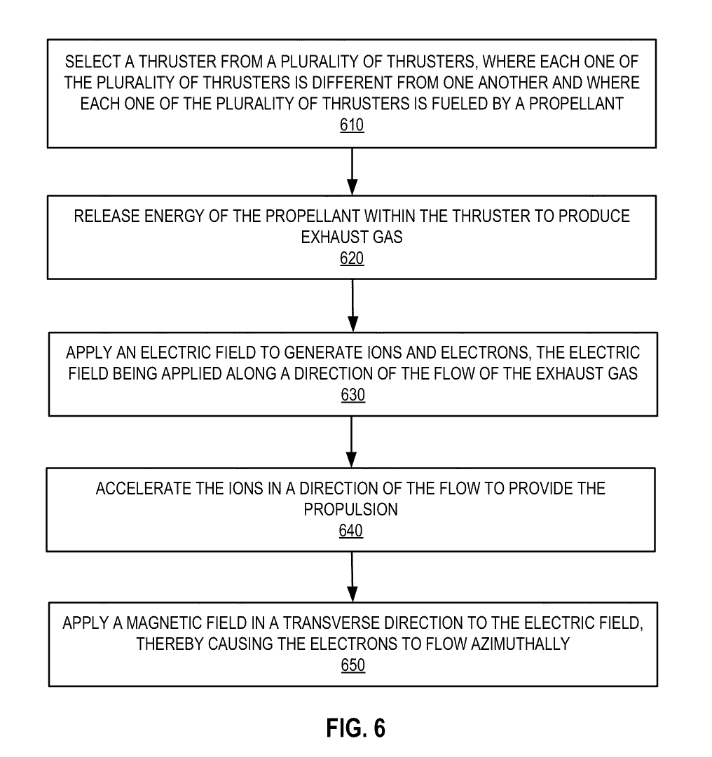

Referring to FIG. 6, an embodiment in the form of a flow chart illustrating a method for producing propulsion using a PFE accelerator described with reference to FIG. 1, FIG. 2A, FIG. 2B, FIG. 3, FIG. 4, and FIG. 5 is shown. At step 610, a thruster is selected from a plurality of thrusters. Each one of the plurality of thrusters is different from one another, and each one of the plurality of thrusters is fueled by a propellant. The common propellant is selectable to be one of a monopropellant and a bipropellant. At step 620, energy stored within the propellant is released within the thruster to produce an exhaust gas. At step 630, an electric field is applied to generate ions and electrons, the electric field being applied along a direction of the exhaust flow. For example, application of an electric field heats the exhaust gas to release the electrons, thereby resulting in partial ionization. At step 640, the ions are accelerated by the electric field in the direction of the flow to provide the propulsion. At step 650, a magnetic field is applied in a transverse direction to the electric field, thereby causing the electrons to flow in an azimuthal direction. Various steps described above may be added, omitted, combined, altered, or performed in different orders. For example, step 630 and step 650 may be performed concurrently (in parallel) to improve the propulsion.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

What is claimed:

1. A hybrid propulsion system, comprising:
a thruster operable to release energy from a propellant, thereby producing an exhaust gas, the thruster being selectable from one of a plurality of thrusters that are different from one another; and
a plasma fuel engine (PFE) accelerator coupled to the thruster in a tandem arrangement, the PFE accelerator provides an electric field and a magnetic field, the electric field being aligned to accelerate the exhaust gas and the magnetic field being aligned transversely to the electric field.

2. The hybrid propulsion system of claim 1, wherein the plurality of thrusters include a chemical thruster and an arcjet thruster.

3. The hybrid propulsion system of claim 1, wherein the propellant is selectable to be one of a monopropellant and a bipropellant.

4. The hybrid propulsion system of claim 1, wherein the thruster includes:
an energy releaser operable to release the energy from the propellant and produce the exhaust gas; and
a nozzle for constricting a flow of the exhaust gas, wherein the flow of the exhaust gas generates an adjustable level of a thrust and an adjustable level of a specific impulse, wherein the PFE accelerator accelerates the exhaust gas to augment the adjustable level of the specific impulse.

5. The hybrid propulsion system of claim 1, wherein the PFE accelerator includes:
a plasma generator to partially ionize the exhaust gas;
an electric field generator to provide the electric field, the electric field being aligned in a direction of a flow of the exhaust gas; and
a magnetic field generator to provide the magnetic field.

6. The hybrid propulsion system of claim 5, wherein the electric field generator is configured to generate the electric field having a strength approximately between 1,000 to 10,000 volts per meter.

7. The hybrid propulsion system of claim 5, wherein the magnetic field generator includes magnets to provide a magnetic field strength of approximately 0.1 Tesla when a density of the exhaust gas is approximately 10 raised to the power of 16 molecules per cubic centimeter.

8. The hybrid propulsion system of claim 1, wherein the electric field causes a partial ionization of the exhaust gas.

9. The hybrid propulsion system of claim 8, wherein the partial ionization of the exhaust gas generates ions and electrons, wherein the electric field causes the ions to accelerate in the direction of the flow of the exhaust gas and the magnetic field causes the electrons to flow in an azimuthal direction.

10. The hybrid propulsion system of claim 8, wherein the partial ionization of the exhaust gas is approximately equal to 10 to the power of −5.

11. The hybrid propulsion system of claim 1, wherein a density of the exhaust gas is approximately 100 to 1000 times greater than a density of an exhaust gas of a Hall thruster fueled by an inert gas propellant that is different than the propellant.

12. The hybrid propulsion system of claim 1, wherein a velocity of the exhaust gas is at least approximately 1000 meters per second.

13. The hybrid propulsion system of claim 1, wherein the PFE accelerator maintains the exhaust gas in a plasma state without seeding.

14. The hybrid propulsion system of claim 1, wherein the PFE accelerator is operable as a decelerator to extract momentum from the exhaust gas, wherein the extracted momentum is converted to electrical power.

15. The hybrid propulsion system of claim 1, wherein each one of the plurality of thrusters is fueled by the propellant.

16. A propulsion method comprising:
selecting a thruster from a plurality of thrusters, wherein each one of the plurality of thrusters is different from one another, wherein each one of the plurality of thrusters is fueled by a propellant;
releasing energy of the propellant within the thruster to produce an exhaust gas;
applying an electric field to generate ions and electrons, the electric field being applied along a direction of a flow of the exhaust gas; and
accelerating the ions in the direction of the flow to provide the propulsion.

17. The method of claim 16 further comprising:
applying a magnetic field aligned in a transverse direction to the electric field, thereby causing the electrons to flow in an azimuthal direction.

18. The method of claim 16 wherein the applying of the electric field includes:
heating the exhaust gas to release the electrons.

19. An apparatus comprising:
means for selecting a thruster from a plurality of thrusters, wherein each one of the plurality of thrusters is different from one another, wherein each one of the plurality of thrusters is fueled by a propellant;
means for releasing energy of the propellant within the thruster to produce an exhaust gas;
means for applying an electric field along a direction of a flow of the exhaust gas to generate ions and electrons; and
means for accelerating the ions in the direction of the flow to provide the propulsion.

20. The apparatus of claim 19 further comprising:
means for applying a magnetic field aligned in a transverse direction to the electric field, thereby causing the electrons to flow in an azimuthal direction.
